(19) United States
(12) Patent Application Publication
(10) Pub. No.: US 2026/0168940 A1
(43) Pub. Date: Jun. 18, 2026

(54) SYSTEMS AND METHODS FOR REDUCING INTERFERENCE IN RADIATION PORTAL MONITORS

(71) Applicant: SMITHS DETECTION INC., Edgewood, MD (US)

(72) Inventors: Pavlo Baturin, Kingwood, TX (US); David Dasilva, Piedmont, CA (US)

(21) Appl. No.: 19/126,985

(22) PCT Filed: Oct. 31, 2023
(86) PCT No.: PCT/US2023/078270

§ 371 Date: May 2, 2025

Related U.S. Application Data
(60) Provisional application No. 63/422,558, filed on Nov. 4, 2022.

(51) Int. Cl. G01N 23/04; G01V 5/22; G21F 1/08; G21F 3/00

(52) U.S. Cl. CPC G01N 23/04; G01V 5/22; G21F 1/085; G21F 3/00; G01N 2223/1016; G01N 2223/3307; G01N 2223/5055

(57) ABSTRACT

An object scanning system is provided. The object scanning system includes an X-ray imaging system including an X-ray source and an X-ray detector, the X-ray imaging system configured to image an object as the object moves between the X-ray source and the X-ray detector along a direction of travel relative to the X-ray imaging system, and at least one radiation portal monitor (RPM) panel configured to screen the object as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

### CROSS-REFERENCE TO RELATED APPLICATIONS

This application claims priority to U.S. Provisional Patent Application Ser. No. 63/422,558, filed 4 Nov. 2022, entitled “SYSTEMS AND METHODS FOR REDUCING INTERFERENCE IN RADIATION PORTAL MONITORS”, which is incorporated herein by reference in its entirety.

### BACKGROUND

The embodiments described herein relate generally to radiation portal monitors (RPMs), and more particularly, to reducing X-ray and gamma-ray interference in RPMs.

RPMs are generally designed to detect the presence of nuclear or radiological materials. When an RPM is operated in the close proximity to an X-ray source, a gamma detector on the RPM may sense X-ray radiation from the X-ray source, resulting in the RPM mistakenly characterizing the X-ray radiation as gamma event emitted by a radioactive source. This characterization is undesirable, as it cases false alarms in the system (which may in turn cause delays in scanning objects).

In at least some known systems, to address this issue, gamma detection by the RPM is paused during an X-ray event from the X-ray source. This approach may be referred to as “blanking”. Specifically, in this approach, the RPM is synchronized with a trigger of the X-ray event, so that the RPM detects, but does not count, the X-ray event. This results in effectively vetoing X-ray events, and only counting legitimate gamma events associated with radioactive sources. Although this approach is relatively efficient, there are some drawbacks. Notably, during the blanking window, the RPM also does not count any legitimate gamma events that occur, resulting in a dead time for the system. Further, X-ray events can saturate the gamma detector of the RPM, creating a paralyzing effect for a period of time.

The extent of the paralyzing effect depends on the width of the blanking window and the frequency of the X-ray pulses. For example, many high energy X-ray sources operate at relatively high frequencies (e.g., 1 kHz), which increases the extent of the paralyzing effect and therefore reduces the ability of the RPM to detect radiological threats. Further, the paralyzing effect prevents making the blanking window relatively small, limiting the performance of the RPM.

Further, the blanking approach is only applicable to pulsed X-ray sources. When an X-ray source is operated in a continuous mode, synchronization with the RPM is no longer possible. Similarly, when the RPM is operated near objects that contain naturally occurring radioactive isotopes, any synchronization with the RPM is generally not possible due to the random nature of isotope disintegration. A continuous X-ray source may be, for example, a low (e.g., sub-megaelectronvolt (MeV)) energy X-ray tube for scanning cargo materials continuously in real time. This could be a setup for transmission, backscatter, or any other imaging modality that requires constant X-ray emission to keep up with the fast moving objects. Further, one example of a material including naturally occurring isotopes is a concrete wall. Concrete is commonly used as a shield for high energy radiation produced by linear accelerators. The presence of naturally occurring radioactive isotopes (e.g., Ra-266, Th-232, and K-40) in concrete may contribute to a spatially unequal distribution of background radiation measured by an RPM's gamma detecting unit.

One known approach to overcome these limitations is to increase a stand-off distance where possible. That is, the RPM is placed further away from the active continuous X-ray source (or natural radioactive sources), where the radiation levels are insignificant enough to be detected by gamma detector. However, these distances are typically very large, making such configurations impractical to implement at scanning sites with limited space.

Accordingly, it would be desirable to suppress X-ray interference, while still maintaining performance of the RPM, including in systems that include continuous X-ray sources and/or materials with naturally occurring radioactive isotopes.

### BRIEF SUMMARY

In one aspect, an object scanning system is provided. The object scanning system includes an X-ray imaging system including an X-ray source and an X-ray detector, the X-ray imaging system configured to image an object as the object moves between the X-ray source and the X-ray detector along a direction of travel relative to the X-ray imaging system, and at least one radiation portal monitor (RPM) panel configured to screen the object as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

In another aspect, a method of scanning an object is provided. The method includes imaging the object using an X-ray imaging system as the object moves between an X-ray source and an X-ray detector along a direction of travel relative to the X-ray imaging system, and screening the object using at least one radiation portal monitor (RPM) panel as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

### BRIEF DESCRIPTION OF THE DRAWINGS

FIG. 1A is a schematic diagram of an example embodiment of a radiation portal monitor (RPM).

FIG. 1B is a graph illustrating a signal response of a photomultiplier tube (PMT) to an X-ray event.

FIG. 1C is a graph illustrating a signal response of a PMT to multiple X-ray events.

FIG. 2 is a perspective view of a known detection system that includes a plurality of RPM panels.

FIG. 3A is a perspective schematic view of a known detection system.

FIG. 3B is a plan schematic view of the detection system shown in FIG. 3A.

FIG. 4 is a plan schematic view of one embodiment of a detection system.

FIG. 5 is a plan schematic view of the detection system shown in FIG. 4 with a shield member coupled to the RPM panels.

FIG. 6 is a plan schematic view of the detection system shown in FIG. 4 with an anti-scatter grid coupled to the RPM panels.

FIG. 7 is a perspective view of one RPM panel coupled to an anti-scatter grid.

### DETAILED DESCRIPTION

The present disclosure is directed to suppressing X-ray interference in radiation portal monitors. An object scanning system includes an X-ray imaging system including an X-ray source and an X-ray detector, the X-ray imaging system configured to image an object as the object moves between the X-ray source and the X-ray detector along a direction of travel relative to the X-ray imaging system, and at least one radiation portal monitor (RPM) panel configured to screen the object as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

A radiation portal monitor (RPM) is a passive radiation detection system designed to provide non-intrusive means of screening vehicles, people, or other objects for the presence of nuclear or radiological materials. As discussed above, high frequency pulsed X-ray sources (such as X-ray imaging systems) may interfere with gamma detection capabilities of RPMs.

At least some known implementations for suppressing X-ray interference have limitations. For example, in one known technique, a counter on the RPM is disabled during an X-ray event. This is referred to as “blanking”. When blanking, however, the RPM is also unable to detect any legitimate gamma events. For example, if a 100 microsecond (μs) blanking window is applied to gate off a 1 kHz pulsed X-ray source, the result is that the RPM is “blind” (i.e., unable to detect legitimate events) for 100 milliseconds (ms) per every second (i.e., 10% dead time). Further, RPM saturation creates limitations on how much the blanking window can be reduced.

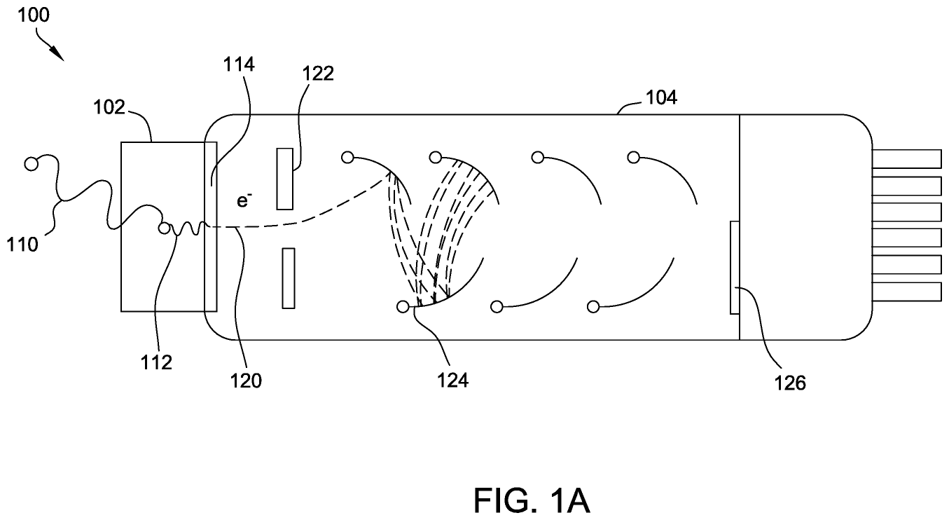

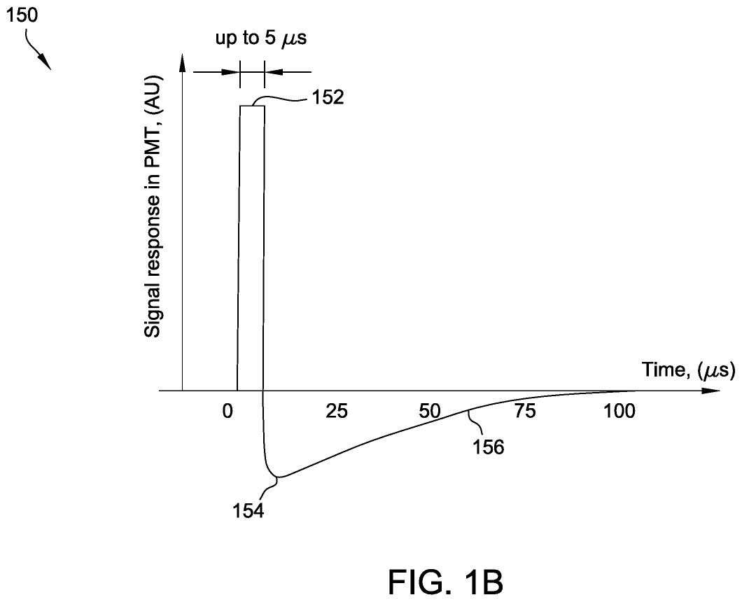

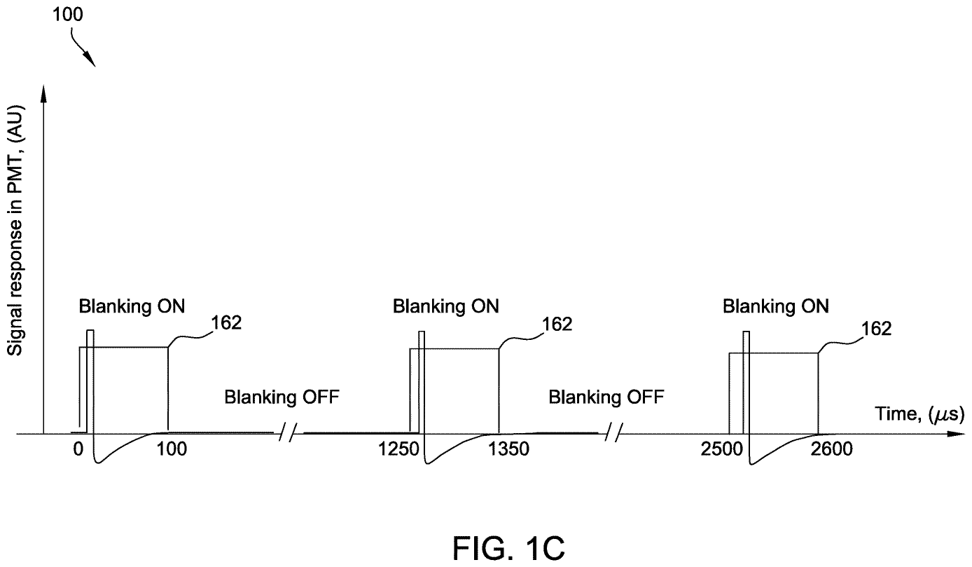

RPM systems typically include a gamma detector and a neutron detector. Gamma detectors measure photons emitted from radioactive materials. FIG. 1A is a schematic diagram of an example embodiment of an RPM 100. RPM 100 includes a scintillator 102 coupled to a photomultiplier tube (PMT) 104. During operation, high energy photons 110 (e.g., X-ray or gamma ray radiation) incident on scintillator 102 are converted into low energy photons 112 by scintillator 102. Low energy photons 112 then enter PMT 104 through a photocathode 114 that converts the low energy photons 112 into electrons 120. Subsequently, electrons 120 are directed by a focusing electrode 122 through a series of dynodes 124, greatly increasing the number of electrons 120. The large number of electrons 120 reaching an anode 126 generate a detectable current pulse, enabling RPM 100 to detect and count an event.

In the occurrence of an X-ray event, the X-ray photons are essentially indistinguishable from gamma photons that are emitted by radioactive sources. However, although PMT 104 may function well at the low emissions rates associated with radioactive source gamma events, high energy X-ray events may saturate PMT 104. The saturated signal temporarily paralyzes the electronics of RPM 100 and creates overshoot effects.

For example, FIG. 1B is a graph 150 illustrating a signal response of PMT 104 to an X-ray event. As shown in FIG. 1B, the X-ray event causes a signal spike 152, followed by an overshoot 154 that has a relatively length recovery tail 156 to return to zero. Overshoot 154 relates to an alternating current (AC) coupling effect, and may be addressed by adjusting capacitance values on affected electronics. This may help mitigate overshoot 154, but will not completely eliminate it.

When using a blanking approach, the blanking window should take overshoot 154 and the corresponding recovery tail 156 into account. FIG. 1C is a graph 160 illustrating a signal response of PMT 104 to multiple X-ray events. As shown in FIG. 1C, blanking windows 162 are wide enough to cover spike 152, overshoot 154, and recovery tail 156 of each X-ray event. Accordingly, although spike 152 may be relatively short (e.g., 5 μs), overshoot 154 and recovery tail 156 cause blanking windows 162 to be relatively long (e.g., 100 μs).

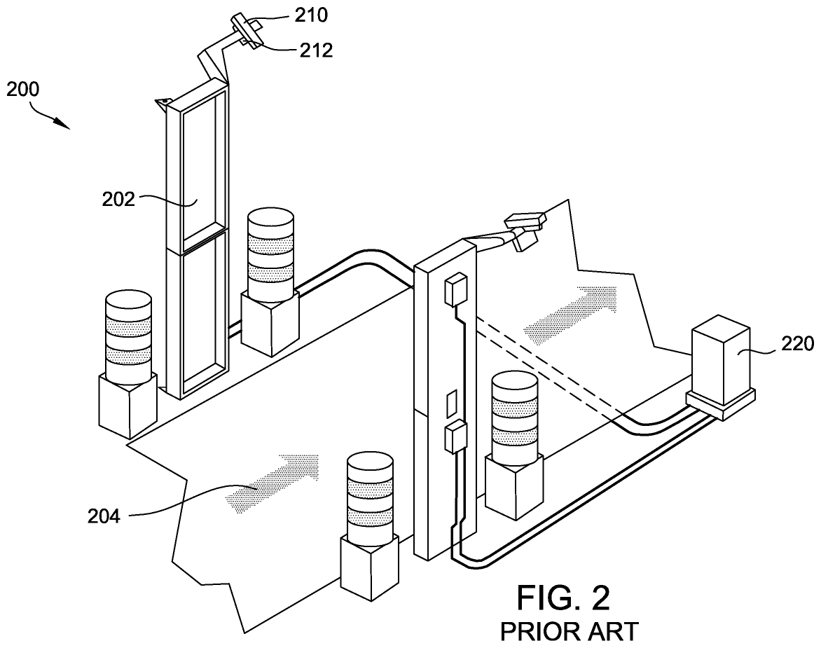

FIG. 2 is a perspective view of a known detection system 200 that includes a plurality of RPM panels 202. Specifically, detection system 200 is configured to screen vehicles. As shown in FIG. 2, detection system 200 includes four RPM panels 202 oriented perpendicular to a direction of travel 204 (i.e., a normal vector of a scintillator surface of each RPM panel 202 is perpendicular to direction of travel 204). Direction of travel 204 is the direction that a vehicle travels through system 200 during scanning. In this embodiment, two RPM panels 202 are stacked atop one another on each side of system 200. System 200 also includes one or more cameras 210 for imaging the vehicle and one or more lights 212 for illuminating the vehicle. System also includes a control system 220 configured to power and control operation of RPM panels 202, camera(s) 210, and light(s) 212.

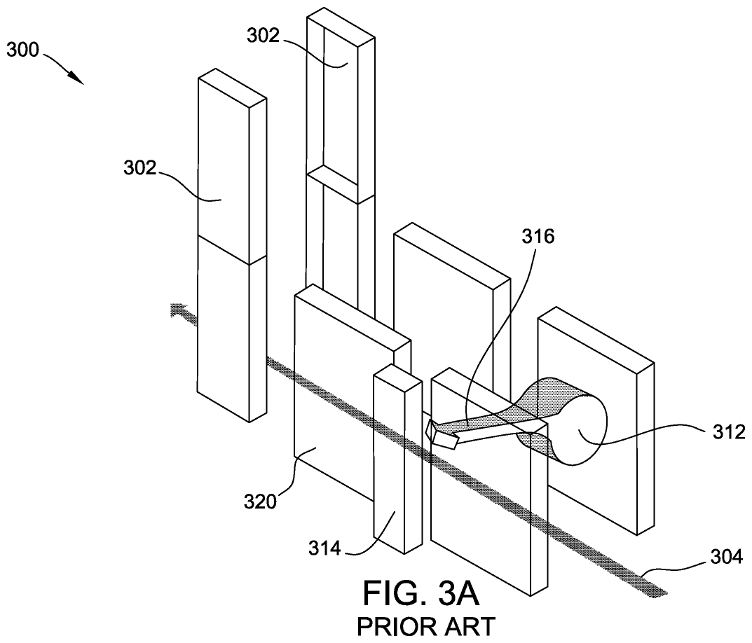

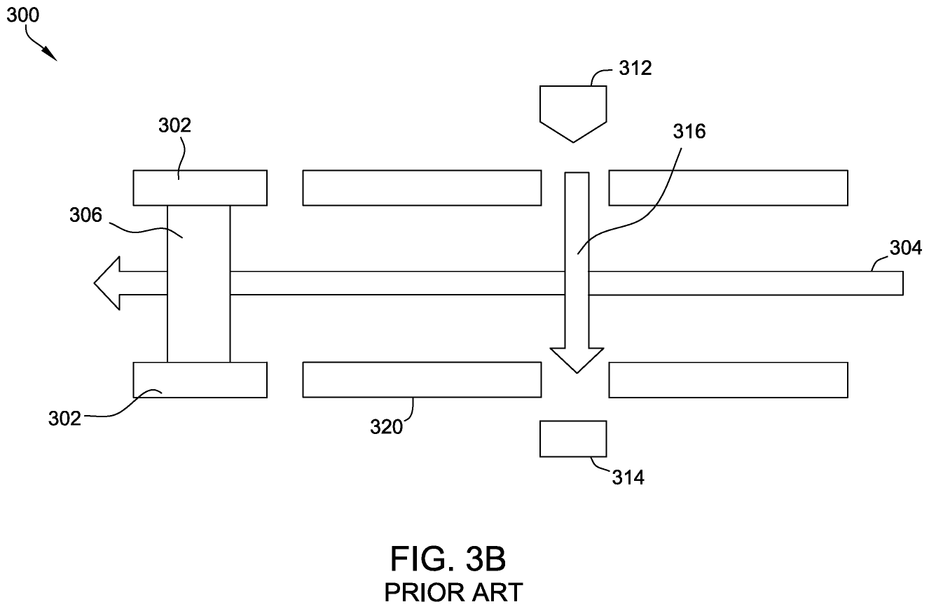

FIG. 3A is a perspective schematic view of a known detection system 300 (similar to system 200 (shown in FIG. 2)). FIG. 3B is a plan schematic view of detection system 300. System 300, like system 200, includes a plurality of RPM panels 302 oriented perpendicular to a direction of travel 304 (forming a rectangular monitoring zone 306). System 300 further includes an X-ray source 312 (e.g., a continuous X-ray source) and an X-ray detector 314, which collectively form an X-ray imaging system.

X-rays 316 generally travel from X-ray source 312 towards X-ray detector 314. However, X-rays 316 emitted from X-ray source 312 may scatter off of the vehicle or object being scanned. For example, at least some X-rays 316 may impinge upon RPM panels 302, interfering with operation of RPM panels 302.

For X-ray shielding purposes, as shown in FIGS. 3A and 3B, system 300 includes a plurality of shield walls 320. Shield walls 320 may be, for example, concrete walls. As noted above, concrete contains naturally occurring radioactive isotopes that may decay. Accordingly, isotope decay from shield walls 320 may also interfere with operation of RPM panels 302.

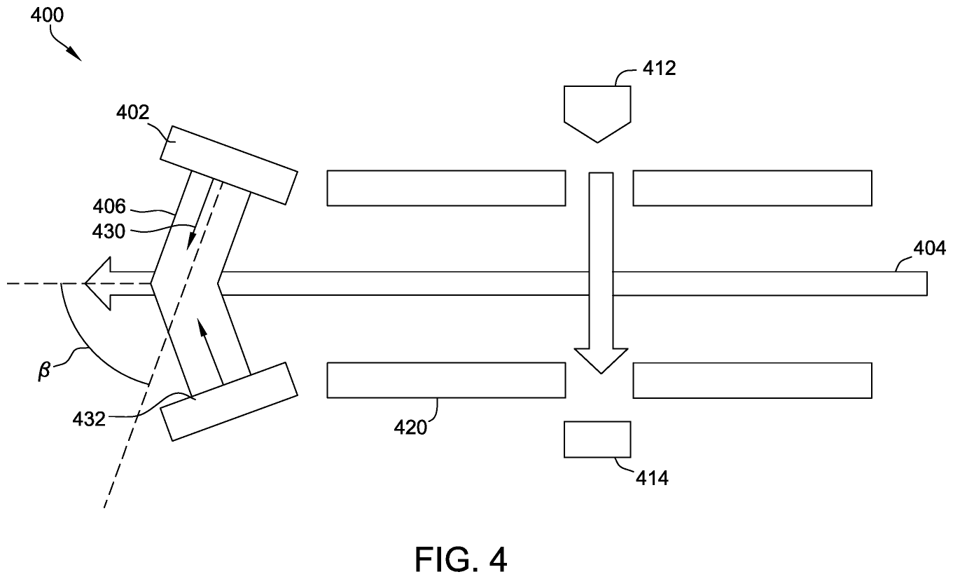

FIG. 4 is a plan schematic view of one embodiment of a detection system 400. Like detection system 300 (shown in FIGS. 3A and 3B), detection system 400 includes RPM panels 402, an X-ray source 412, an X-ray detector 414, and shield walls 420. However, unlike detection system 300, RPM panels 402 in detection system 400 are oriented obliquely relative to a direction of travel 404 and formed a chevron-shaped monitoring zone 406. That is, RPM panels 402 are oriented such that they face at least partially away from X-ray source 412, X-ray detector 404, and shield walls 420.

Specifically, a normal vector 430 from a scintillator surface 432 of each RPM panel 402 is oriented obliquely relative to direction of travel 404. For example, an angle, β, defined between normal vector 430 and direction of travel 404 is less than 90°, as shown in FIG. 4. For example, in some embodiments, the angle β is between 10° and 80°, more particularly between 35° and 55°, and more particularly approximately 45°.

The particular angle β may be optimized based on the specific geometry of X-ray imaging components and shield walls. Further, the oblique angle B increases (relative to system 300) the distance between RPM panels 402 and the object being monitored, which may impact operation of RPM panels 402 in monitoring the object. Accordingly, those of skill in the art will appreciate that different embodiments may orient RPM panels 402 at different angles β.

Because RPM panels 402 face at least partially away from X-ray source 412, X-ray detector 404, and shield walls 420, scattered X-rays are less likely to impinge on RPM panels 402 and interfere with the operation of RPM panels 402. Further, RPM panels 402 also face away from shield walls 420, reducing the likelihood that gamma radiation from isotope decay in shield walls 420 will impact and impair operation of RPM panels 402.

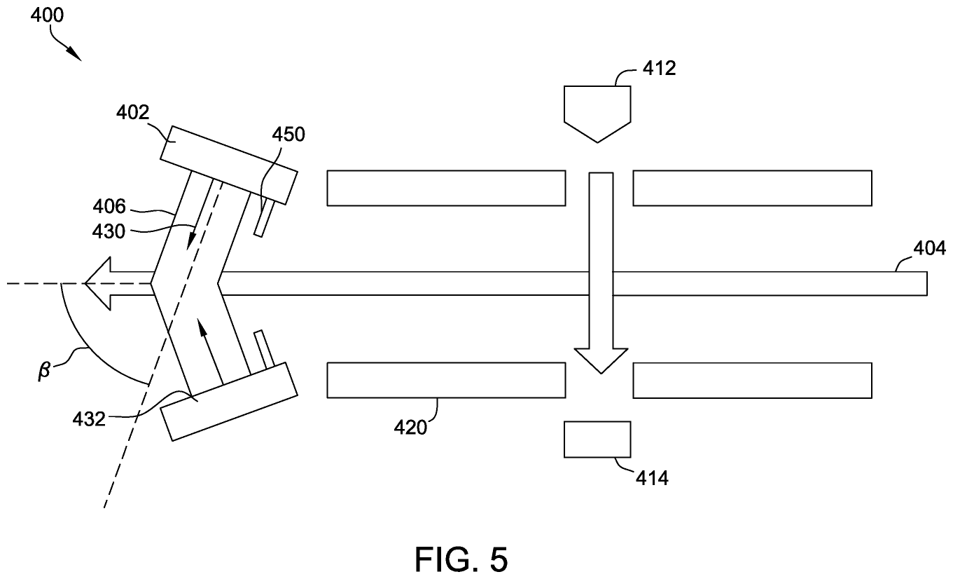

FIG. 5 is a plan schematic view of system 400 with a shield member 450 coupled to RPM panels 402. In this embodiment, shield member 450 extends from RPM panel 402 in a direction generally parallel to normal vector 430. Alternatively, shield member 450 may extend from RPM panel 402 at any suitable angle. Shield member 450 is made of an X-ray absorbing material, such as steel, lead, tungsten, etc. Accordingly, shield member 450 further assists in preventing stray X-ray and/or gamma rays from reaching RPM panel 402. In such embodiments, the RPM panels 402 may need to be positioned further apart from one another to enable the object being scanned to clear the shield members 450. The thickness and height of shield members 450 may be optimized relative to specific geometries of system 400.

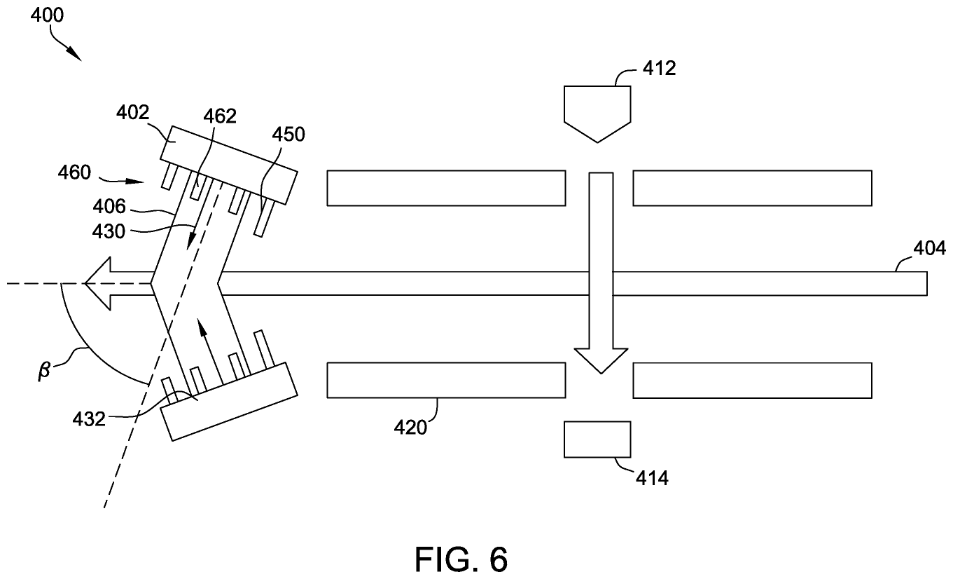

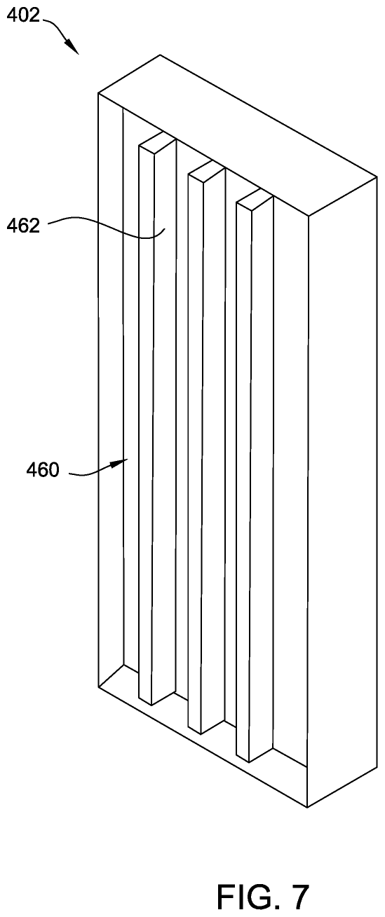

FIG. 6 is a plan schematic view of system 400 with an anti-scatter grid 460 coupled to RPM panels 402. FIG. 7 is a perspective view of one RPM panel 402 coupled to an anti-scatter grid 460. In this embodiment, anti-scatter grid 460 includes a plurality of grid members 462 (e.g., three grid members 462) extends from RPM panel 402 in a direction generally parallel to normal vector 430. Alternatively, grid members 462 may extend from RPM panel 402 at any suitable angle. Further, anti-scatter grid 460 may include any suitable number of grid members 462 arranged at any suitable spacing relative to one another. The spacing, height, and thickness of grid members 462 may be optimized relative to specific geometries of system 400.

Similar to shield member 450, grid members 462 may be made of an X-ray absorbing material, such as steel, lead, tungsten, etc. Accordingly, grid members 462 further assist in preventing stray X-ray and/or gamma rays from reaching RPM panel 402. In the embodiment shown, grid members 462 are shorter than shield members 450. Alternatively, grid members 462 and shield members 450 may have any suitable dimensions.

As noted above, the oblique angle of the RPM panels and the dimensions of the shield members and/or grid members may be adjusted based on the specific geometries of a given system. To determine example values, X-ray scattering from a 6 MeV pulsed X-ray source in a system similar to system 400 (shown in FIGS. 4-6) was modeled. Specifically, using mathematical models, it was determined that RPM panels may experience, due to scattering of X-rays from a 6 MeV X-ray source off of an object being scanned, a spectrum with a maximum photon energy of up to 0.73 MeV. Notably, designing radiation protection to shield RPM panels from such energies is possible. For example, one inch of steel (i.e., 2.54 centimeters (cm)) may stop about 85% of the scattered radiation, and one inch of lead may stop about 99.3% of the scattered radiation. Further, composite radiation protection components (i.e., made of multiple different material) may also be used.

Continuous X-ray radiation sources typically operate at lower levels than 6 MeV. Accordingly, RPM panels may experience, due to scattering of X-rays from a continuous X-ray source off of an object being scanned, a spectrum with a maximum photon energy of up to 0.12 MeV, or up to 0.22 MeV. An inch (i.e., 2.54 cm) of steel or 0.25 centimeters (cm) of lead is sufficient to stop all 0.12 MeV photons, whereas 4 cm of steel or 0.5 cm of lead is sufficient to stop all 0.22 MeV photons. Again, these thicknesses are only examples, but they validate the feasibility of the embodiments described herein.

Example embodiments of suppressing X-ray interference in radiation portal monitors are described herein. An object scanning system includes an X-ray imaging system including an X-ray source and an X-ray detector, the X-ray imaging system configured to image an object as the object moves between the X-ray source and the X-ray detector along a direction of travel relative to the X-ray imaging system, and at least one radiation portal monitor (RPM) panel configured to screen the object as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A object scanning system comprising:
an X-ray imaging system comprising an X-ray source and an X-ray detector, the X-ray imaging system configured to image an object as the object moves between the X-ray source and the X-ray detector along a direction of travel relative to the X-ray imaging system; and
at least one radiation portal monitor (RPM) panel configured to screen the object as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

2. The object scanning system of claim 1, wherein the at least one RPM panel comprises a plurality of RPM panels.

3. The object scanning system of claim 1, wherein the oblique angle is between 10° and 80°.

4. The object scanning system of claim 1, further comprising a shield member coupled to the at least one RPM panel, the shield member made of an X-ray absorbing material.

5. The object scanning system of claim 4, wherein the shield member is made of at least one of steel, lead, and/or tungsten.

6. The object scanning system of claim 4, wherein the shield member extends away from the at least one RPM panel parallel to the normal vector.

7. The object scanning system of claim 1, further comprising at least one shield wall positioned between the X-ray imaging system and the at least one RPM panel.

8. The object scanning system of claim 1, further comprising an anti-scatter grid coupled to the at least one RPM panel, the anti-scatter grid including a plurality of grid members.

9. The object scanning system of claim 8, wherein the plurality of grid members are made of at least one of steel, lead, and/or tungsten.

10. The object scanning system of claim 9, wherein the plurality of grid members extend away from the at least one RPM panel parallel to the normal vector.

11. A method of scanning an object, the method comprising:
imaging the object using an X-ray imaging system as the object moves between an X-ray source and an X-ray detector along a direction of travel relative to the X-ray imaging system; and
screening the object using at least one radiation portal monitor (RPM) panel as the object moves along the direction of travel, wherein a normal vector for a scintillator surface of the at least one RPM panel forms an oblique angle with the direction of travel, and wherein the at least one RPM panel faces at least partially away from the X-ray source and the X-ray detector.

12. The method of claim 11, wherein the at least one RPM panel includes a plurality of RPM panels.

13. The method of claim 11, wherein the oblique angle is between 10° and 80°.

14. The method of claim 11, wherein a shield member is coupled to the at least one RPM panel, the shield member made of an X-ray absorbing material.

15. The method of claim 14, wherein the shield member is made of at least one of steel, lead, and/or tungsten.

16. The method of claim 14, wherein the shield member extends away from the at least one RPM panel parallel to the normal vector.

17. The method of claim 11, wherein at least one shield wall is positioned between the X-ray imaging system and the at least one RPM panel.

18. The method of claim 11, wherein an anti-scatter grid is coupled to the at least one RPM panel, the anti-scatter grid including a plurality of grid members.

19. The method of claim 18, wherein the plurality of grid members are made of at least one of steel, lead, and/or tungsten.

20. The method of claim 18, wherein the plurality of grid members extend away from the at least one RPM panel parallel to the normal vector.
